(19) United States
(12) Patent Application Publication
(10) Pub. No.: US 2005/0163509 A1
(43) Pub. Date: Jul. 28, 2005

(54) Acoustoelectric transducer using optical device

(76) Inventors: Okihiro Kobayashi, Yokohama-shi (JP); Nobuhiro Miyahara, Tokyo (JP); Tamio Takeda, Tokyo (JP); Yutaka Hattori, Tokyo (JP); Hiroshi Miyazawa, Tokorozawa-shi (JP)

Correspondence Address: ERIC ROBINSON, PMB 955, 21010 SOUTHBANK ST., POTOMAC FALLS, VA, 20165, US

(21) Appl. No.: 10/148,468

(22) PCT Filed: Dec. 1, 2000
(86) PCT No.: PCT/JP00/08537

(30) Foreign Application Priority Data
Dec. 3, 1999 (JP) 11-345438
Dec. 3, 1999 (JP) 11-353621
Dec. 3, 1999 (JP) 11-353700
Jan. 17, 2000 (JP) 2000-008380

(51) Int. Cl. H04B 10/00

(52) U.S. Cl. 398/132

(57) ABSTRACT

An optical acoustoelectric transducer receives light reflected by a vibrating board and detects the displacement of the vibrating board. A surface-emitting luminescent device having a substantially uniform concentric intensity distribution of light emission is placed in the center of a common substrate. A photodetector element is provided to surround the luminescent device. A lens is also provided in the optical path between the substrate and the vibrating board to converge the light traveling toward and from the vibrating board.

### TECHNICAL FIELD

The present invention relates to an optical acoustoelectric transducer for converting vibration displacement of a vibrating board into an electric signal by using an optical device. It especially provides an effective technique in the case of using a vertical cavity surface emitting laser (VCSEL) as a luminescent device.

### BACKGROUND ART

As for optical acoustoelectric transducers using optical devices, various ones have been developed and implemented so far. For instance, Japanese Patent Application Laid-Open No. 8-297011 discloses an optical fiber sensor using a pair of optical fibers and having a configuration wherein light is irradiated to a vibration medium from one optical fiber connected to a light source and the light is detected by the other optical fiber, indicating that it is applicable to a microphone. In addition, U.S. Pat. No. 6,055,080 also discloses the configuration of an optical microphone using optical fibers. As opposed to this, there is a proposal of an optical microphone having adopted the configuration wherein a luminescent device and a photodetector element are placed on the same plane by optically completely separating them with a barrier plate in order to solve a problem of the optical microphone configuration using the optical fibers (its characteristics significantly depend on a light incident angle on a vibration plane and position accuracy) (Japanese Patent Application Laid-Open No. 11-252696). Moreover, Japanese Patent Application Laid-Open No. 61-121373 and Japanese Patent Application Laid-Open No. 61-121374 disclose the configuration of a semiconductor surface luminescent device and a manufacturing method thereof. Furthermore, Japanese Patent Application Laid-Open No. 11-30503 (corresponding to U.S. Pat. No. 5,771,091) discloses an optical fiber sensor wherein a solid optical guide is provided to the luminescent device and the photodetector element respectively with an angle to a vibrating board, and Japanese Patent Application Laid-Open No. 2000-88520 (corresponding to U.S. Pat. No. 6,091,497) discloses an optical fiber sensor, as an improved version of the above described optical fiber sensor, having the configuration wherein an output terminal of an optical guide on a luminescent device side and an input terminal of the optical guide on a photodetector element side are mutually in contact. In addition, Japanese Patent Application Laid-Open No. 61-280686 discloses the configuration wherein a buried condenser lens is placed on a light emitting side in a semiconductor surface luminescent device, and U.S. Pat. No. 5,262,884 discloses an optical microphone wherein the condenser lens is directly placed on a luminescent device side of a vibrating board so as to improve sensitivity and light modulation width.

FIG. 14 is a diagram showing an overview configuration of an optical microphone apparatus 10 of the past.

A vibrating board 2 is placed close to an entrance of a container 1. And a light emitting diode 3 and a phototransistor or a photodiode 5 are mounted in the container 1, and an incident light L1 from the light emitting diode 3 is reflected on an inside surface 2b of the vibrating board 2, and this reflected light L2 is received by the photodetector element 5 such as the phototransistor or the photodiode. An incident sound wave 7 to the optical microphone apparatus 10 gets incident from an outside surface 2a of the vibrating board 2, and vibrates this vibrating board.

As the vibrating board 2 vibrates, the direction of the reflected light L2 changes and gets incident on a different light-receptive surface 5a of the photodetector element 5. It is possible to detect displacement of the vibrating board 2 by detecting the change of this light-receptive surface 5a. In addition, there are the cases where a lens 4 or a lens 6 is used for the purpose of alignment of the incident light L1 and the reflected light L2.

Thus, the optical microphone apparatus in the past radiates the incident light L1 to the vibrating board 2 from the luminescent device 3 at a certain angle, and receives the reflected light L2 at a reflection angle corresponding to that incidence angle, so that the displacement of the vibrating board 2 is detected according to the change of the reflection angle of the reflected light L2 to reproduce the sound wave.

FIG. 15 is a sectional view showing the configuration of required sections of a head portion of another optical microphone apparatus of the past.

In this past example, as in FIG. 14, it is also possible to convert vibration of a vibrating board 72 into the electric signal by detecting it not contacting the vibrating board 72 so that it is no longer necessary to place a vibration detecting system on the vibrating board 72, weight of the vibrating portion can be rendered lighter, and feeble variation of the sound wave can be sufficiently followed.

Here, a luminescent device 73 and a photodetector element 74 are mounted on a substrate 75 at predetermined angles Ψ1 and Ψ2 respectively, and the substrate 75 and the vibrating board are placed close so as to become almost parallel.

For this reason, an incidence angle Ψ1 and a reflection angle Ψ2 become equal between the incident light from a luminescent device 73 and the reflected light on the vibrating board.

The structure of the optical microphone apparatus of the past as mentioned above requires high accuracy of several tens of microns or less for the alignment between the luminescent device such as a light emitting diode or the like and the photodetector element such as the phototransistor or the photodiode. For this reason, there was a problem, in case of configuring the luminescent device, the photodetector element, the vibrating board and so on with individual components, that it leads to deterioration of yield because highly accurate alignment is difficult in manufacturing products. There was also a limit to miniaturization of the optical microphone apparatus.

As for this optical microphone apparatus of the past technology, the incidence angle Ψ1 and the reflection angle Ψ2 become equal between the incident light and the reflected light on the vibrating board as mentioned above. To make the incidence angle and the reflection angle equal in this way, it is necessary to mount the luminescent device and the photodetector element on the substrate with the predetermined angles Ψ1 and Ψ2 (Ψ1=Ψ2) respectively.

If the structure of the head portion of the optical microphone is miniaturized, however, it is not always easy, because of variation in components comprising the head portion, to mount the luminescent device and the photodetector element on the substrate with the predetermined angles, and moreover, to adjust the incidence angle and the reflection angle.

In addition, it requires a large number of man-hours to mount the luminescent device and the photodetector element on the substrate with the predetermined angles, and besides, it accompanies a very difficult work to adjust a focus of the reflected light to exactly fit the light-receptive surface of the photodetector element.

An objective of the present invention is to provide an optical microphone apparatus for resolving the above fault of the optical microphone apparatuses in the past, capable of easily miniaturizing the apparatus and moreover, aligning the photodetector element and the vibrating board with high accuracy, which is also easily mass-produced and besides, able to obtain even reflection.

Another objective of the present invention is to provide, for the purpose of obtaining a signal of a high S/N ratio without increasing an amplification factor of an amplifier provided to the microphone apparatus, the optical microphone apparatus capable of enhancing acoustoelectric conversion efficiency by increasing change of movement width of the reflected light when receiving it on the photodetector element or having the reflected light from the vibrating board efficiently received.

### DISCLOSURE OF THE INVENTION

In order to attain the above objectives, in a first phase of the present invention, an optical acoustoelectric transducer has a luminescent device and a photodetector element placed on the same substrate, where light is emitted to a vibrating board mounted in a position opposite the above described substrate from the above described luminescent device, and the reflected light from the above described vibrating board is received on the above described photodetector element so as to detect displacement of the above described vibrating board. Therein, a vertical surface-emitting luminescent device having a substantially uniform concentric intensity distribution of light emission around the center of a light emitting area is placed in the center of the above described substrate and the above described photodetector element is provided to surround the above described luminescent device. And typically, the photodetector element is comprised of a plurality of concentrically placed devices. Furthermore, it has a differential detector for detecting a differential signal of a signal detected by the photodetector element belonging to a different concentric circle so as to detect the displacement of the above described vibrating board from output of the above described differential detector. In addition, it is preferable that the luminescent device and the photodetector element are formed in the same shape on the substrate, the substrate is comprised of a gallium arsenide wafer, and the vibrating board is mounted almost in parallel with and close to the substrate. Furthermore, in the present invention, a lens element for focusing incident light from the above described luminescent device to lead it to the above described vibrating board and focusing diverging reflected light from the above described vibrating board to lead it to the above described photodetector element is placed on an optical path between the above described substrate and the above described vibrating board so as to have the above described luminescent device on an optical axis thereof for the purpose of increasing change of movement width of the reflected light when receiving it on the photodetector element.

And it is preferable that the above described lens element is a microlens or a hologram, and the vibrating board is placed to be located in a position slightly farther than a focus position of this lens element.

Next, in a second phase of the present invention, the optical acoustoelectric transducer has the vibrating board for vibrating due to sound pressure, the luminescent device for irradiating a light beam on the above described vibrating board, the photodetector element for receiving the reflected light of the above described light beam irradiated on the above described vibrating board and outputting the signal corresponding to vibration displacement of the above described vibrating board, and the substrate for mounting the above described luminescent device and the above described photodetector element. Therein, the above described luminescent device and the above described photodetector element are placed on the above described substrate so that a light emitting surface of the above described luminescent device and a light-receptive surface of the above described photodetector element are parallel and almost on the same plane, the above described vibrating board is inclined by a predetermined angle to the above described substrate, and the above described light beam emitted almost vertically to the above described light emitting surface from the above described luminescent device is irradiated on the above described vibrating board, and then the above described reflected light on the above described vibrating board is received by the above described photodetector element.

And it is preferable that the area on which the incident light is irradiated within the surface of the vibrating board is a mirror finished surface, and this area is formed in an annular shape or in a circular spot shape. Furthermore, a plurality of the photodetector elements are arranged against the luminescent device in a linear shape, in a circular shape or in a rectangular shape, and also a plurality of the luminescent devices are arranged.

### BRIEF DESCRIPTION OF THE DRAWINGS

FIG. 1 is a diagram for explaining a basic principle of an optical acoustoelectric transducer related to a first phase of the present invention;

FIG. 2 is a diagram showing intensity distribution of light emission of a vertical cavity surface emitting laser used in the present invention;

FIG. 3 is a diagram showing two-dimensional intensity distribution of light emission of a luminescent device used in the present invention;

FIG. 4 is a diagram for explaining a first principle of modulating a received light amount of the optical acoustoelectric transducer related to the first phase of the present invention;

FIG. 5 is a diagram showing an example of a configuration of an electrical equivalent circuit of the optical acoustoelectric transducer of the present invention;

FIG. 6 is a diagram showing another example of the configuration of the electrical equivalent circuit of the optical acoustoelectric transducer of the present invention;

FIG. 7 is a diagram for explaining a second principle of modulating a received light amount of the optical acoustoelectric transducer related to the first phase of the present invention;

FIG. 8 is a diagram showing the intensity distribution of the light emission of the vertical cavity surface emitting laser used in the present invention;

FIG. 9 is a sectional view showing a configuration of a head portion used for the optical acoustoelectric transducer related to a second phase of the present invention;

FIG. 10 is a diagram showing an example of a vibrating board used for an apparatus related to the second phase of the present invention;

FIG. 11 is a diagram for explaining operation principle of the optical acoustoelectric transducer related to the second phase of the present invention;

FIG. 12 is a sectional view showing the further improved configuration of the head portion used for the optical acoustoelectric transducer related to the second phase of the present invention;

FIG. 13 is a diagram showing an arrangement of photodetector elements used for the apparatus related to the second phase of the present invention;

FIG. 14 is a diagram showing a basic structure of an optical microphone apparatus of the past; and

FIG. 15 is a sectional view showing a structure of the head portion of the optical microphone apparatus of the past.

### BEST MODE FOR CARRYING OUT THE INVENTION

Hereafter, embodiments of an optical acoustoelectric transducer of the present invention will be described by referring to the drawings. Moreover, an optical microphone apparatus that is typical as the optical acoustoelectric transducer is taken as an example.

FIG. 1 is a diagram showing a basic structure of the optical microphone apparatus in a first phase of the present invention.

FIG. 1(a) shows a sectional shape, wherein an electronic circuit board 12 is placed on a bottom 8 of a container 1, and a substrate 9 having luminescent devices and photodetector elements placed thereon is mounted on the board 12. It can also be mounted by electrically connecting the substrate 9 and the board 12 by flip chip bonding for instance. In addition, it is possible, if the bottom 8 is configured by a semiconductor substrate such as silicon, to omit the electronic circuit board 12 since an electronic circuit can be configured thereon. Moreover, the embodiment shown in FIG. 1 uses a vertical cavity surface emitting laser (VCSEL) LD as the luminescent device and a photodiode PD as the photodetector element. The vertical cavity surface emitting laser diode LD in a circular shape is placed in the middle of the substrate 9, and the photodetector elements PD are concentrically provided to surround the LD.

FIG. 1(b) is a plan showing enlarged light receptive and emitting portions of the substrate 9 on which the luminescent device and the photodetector elements shown as enclosed by a dotted line in FIG. 1(a) are mounted.

As shown in the drawing, the luminescent device LD in the circular shape is placed in the center, and the photodetector elements PD1, PD2 . . . PDn are concentrically provided to surround it.

These luminescent devices LD and the photodetector elements PD can be simultaneously manufactured on a gallium arsenide wafer by a semiconductor manufacturing process.

Accordingly, alignment accuracy of the luminescent devices LD and the photodetector elements PD is decided by accuracy of a mask used in the semiconductor manufacturing process, and so it is possible, as the alignment accuracy thereof can be rendered as 1 μm or less, to implement it with high accuracy of a one millionth or less compared to the alignment accuracy of the luminescent device and the photodetector elements of optical microphone devices of the past.

In general, a vertical cavity surface emitting device has a characteristic that its intensity distribution of the light emission is concentrically almost even. Accordingly, radiated light that is radiated toward a vibrating board 2 at a predetermined angle from the luminescent device LD placed in the center is concentrically reflected with the same intensity, and its reflection angle is changed by vibration of the vibrating board 2 due to reception of a sound wave 7 so that it concentrically reaches the photodetector elements PD.

Accordingly, vibration displacement of the vibrating board 2 can be detected by detecting the change of a received light amount of the concentrically placed photodetector elements PD1 . . . PDn. It becomes usable as the optical microphone device since it can detect the intensity of the incident sound wave 7.

Moreover, an electrode 11 is formed in order to drive the luminescent devices LD and the photodetector elements PD or to detect an incident light amount.

Next, the vertical cavity surface emitting laser (hereafter, referred to as VCSEL) used as the luminescent device in the present invention will be described.

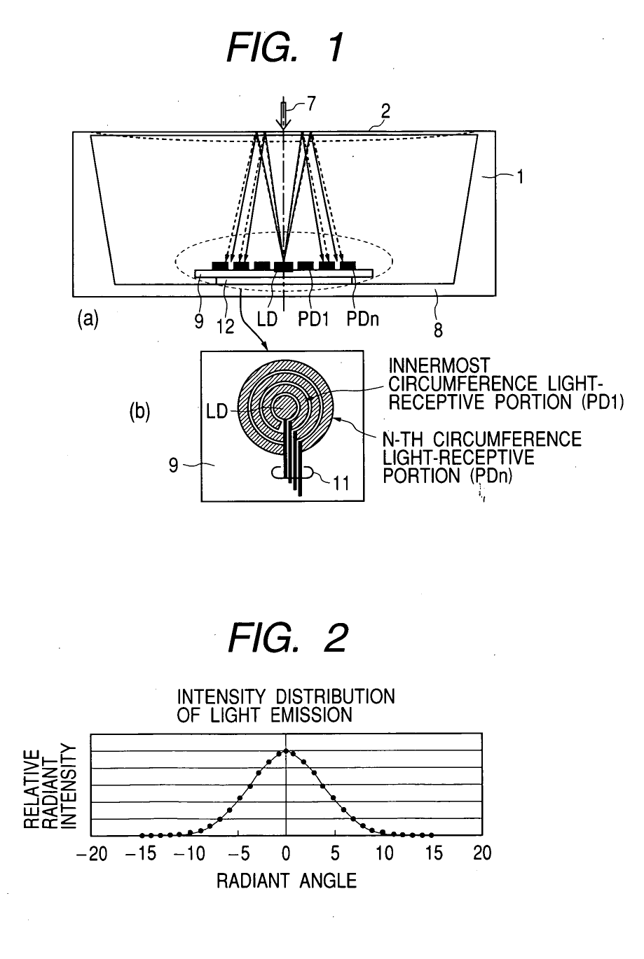

FIG. 2 shows the intensity distribution of the light emission of the VCSEL, and the intensity distribution of radiation is given as Gaussian distribution against in-nucleus as shown in the drawing.

The intensity distribution of the light emission P0 (θ) is shown by an equation (1).
P0(θ)=exp(−α²θ²) (1)

θ: Angle displacement from a perpendicular erected on the light emitting surface (unit: radian)

α: Coefficient stipulating a luminescent spread angle (originally simplified to calculate “1/α²”)

If this light emission distribution coefficient α is calculated as to the case of one dimension, it is represented as an equation (2).
α²=−[ln(h)]/(FAHM/2)² (2)

h: Relative intensity given by measuring light emission distribution of a laser

The angle of radiation is vertical and 1. Half value=0.5. 1/e=0.3183. 1/e²=0.135335.

FAHM: A full angle at half maximum (FAHM) value is usually provided by a manufacturer.

If h=0.5, FAHM=9 degrees,

rad (9/2)=0.07854
α²=−[ln(0.5)]/(0.07854)²=112.369

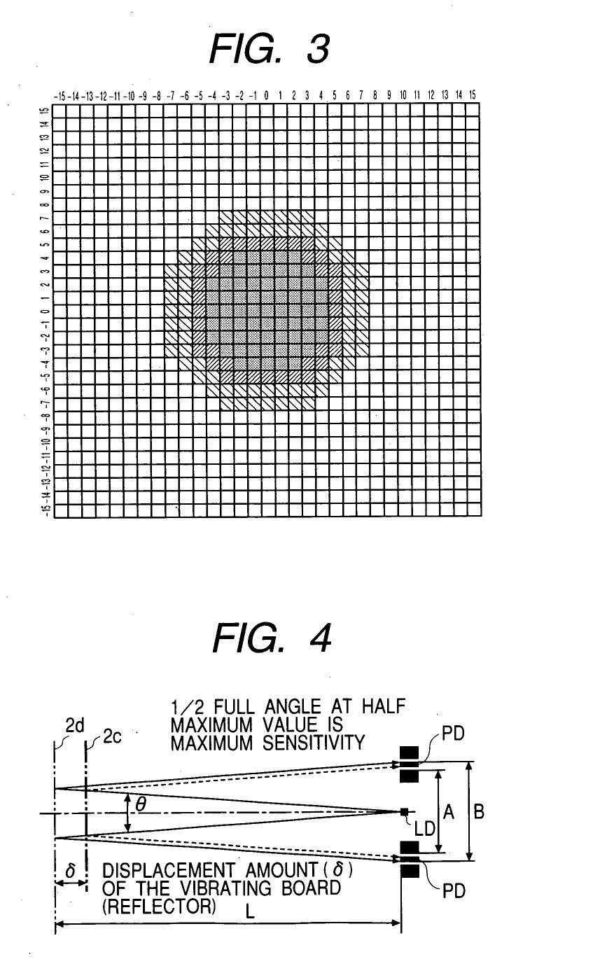

And if calculation is thereby performed for each direction in which the intensity distribution of the light emission is specified, the distribution shown in FIG. 3 is obtained.

FIG. 3 is a diagram showing the intensity distribution of the light emission calculated about two dimensions.

In this case, the two-dimensional intensity distribution of the light emission P0 (θ) is given by an equation (3).
P0(θ)=exp(−α²θ²)·exp(−β²Ψ²) (3)

The calculation is performed for directions θ and Ψ by the same method as distribution calculating coefficients α and β . The light emission distribution coefficient α is given by an equation (4), and the light emission distribution coefficient β is given by an equation (5).
α²=−[ln(h)]/(FAHM/2)² (4)

If h=0.5, FAHM=9 degrees,

rad(9/2)=0.07854
α²=−[ln(0.5)]/(0.07854)²=112.369
β²=−[ln(h)]/(FAHM/2)² (5)

If h=0.5, FAHM=9 degrees,

rad(9/2)=0.07854
β²=−[ln (0.5)]/(0.07854)²=112.369

As apparent from the two-dimensional intensity distribution of the light emission thus obtained, the intensity distribution of the luminescent devices is almost even as to the vertical cavity surface emitting laser.

Accordingly, to efficiently receive laser light emission as the displacement of the vibrating board 2, it is optimum to concentrically place the photodetector elements. And a differential signal of a signal detected by the photodetector element belonging to a different concentric circle concentrically placed is the signal that gives a sound pressure change.

To limit or select a dynamic range of a wave-receptive signal here, it becomes possible to do so by concentrically placing two or more photodetector elements.

In the optical microphone device shown in FIG. 1, it is considered, as the vibrating board 2 is fixed at the end of the container 1, that the vibrating board 2 significantly vibrates in the center and does not vibrate at the ends, that is, it vibrates like a lens, due to the sound pressure. However, it requires considerable sound pressure in the case of thus vibrating like a lens, and besides, it is not necessary to take such lens-like vibration into consideration in the case of the large-size vibrating board of which diameter is 3 mm or so, and it is possible then to consider that the vibrating board 2 is vibrating in its center in parallel and opposite the substrate 9.

FIG. 4 is a diagram for explaining a principle of modulating a received light amount of the optical microphone device of the present invention.

The light irradiated from a luminescent device LD at a predetermined angle is reflected on the vibrating board 2 so that an equivalent to ½ full angle at half maximum value becomes maximum sensitivity, and becomes incident on a photodetector element PD. Moreover, it is assumed that the vibrating board 2 was initially in the position of 2c, and moved to the position of 2d as it vibrated by a displacement amount δ due to the vibration. In addition, it is assumed that the distance between the luminescent device LD, the photodetector element PD and the vibrating board 2 is L and the ½ full angle at half maximum value from the luminescent device LD is θ.

It is assumed that the diameter between the portions receiving the reflected light when the vibrating board 2 was still is A, and the diameter of the reaching distance of the reflected light when the vibrating board 2 moved by the displacement amount δ is B.

Here, θ, L, δ, A and B are changed respectively, and the movement width r of the reflected light is calculated by an equation (6), which results are shown in Table 1.
r=B/2−A2
tan(θ/2)·2·(L+δ)·2·(l−δ) (6)

TABLE 1

| | | | | | Movement |
|---|---|---|---|---|---|
| θ | L | ±δ | A/2 | B/2 | width |
| Degree | μm | μm | μm | μm | μm |
| 6 | 1390 | 0.5 | 146 | 146 | 0.1 |
| 7 | 1390 | 0.5 | 170 | 170 | 0.12 |
| 8 | 1390 | 0.5 | 194 | 195 | 0.14 |
| 9 | 1390 | 0.5 | 219 | 219 | 0.16 |
| 10 | 1390 | 0.5 | 243 | 243 | 0.17 |
| 11 | 1390 | 0.5 | 367 | 268 | 0.19 |
| 12 | 1390 | 0.5 | 292 | 292 | 0.21 |

Thus, the movement width on the circumferential photodetector element is determined by a radiation angle of the luminescent device.

An adequate PD width (larger than 3 microns) is secured by the intended sound pressure and the displacement amount δ of the vibrating board 2. In this case, caution is necessary since, if A and B are rendered too large, the occupied area in the case of forming the luminescent devices and the photodetector elements on the gallium arsenide wafer becomes large and so the number of the luminescent devices and photodetector elements removable per wafer becomes small.

In addition, as shown in FIG. 1(b), it should be designed in consideration of the area required for the electrodes 11 from the luminescent devices and photodetector elements, wire bonding pads connected thereto and so on. Moreover, a 100-micron or less square should be sufficient for the area of each wire bonding pad. Furthermore, a 50-micron or less square should be sufficient for the area of the pad in the case of the flip chip bonding.

Moreover, while the photodetector element concentrically formed can be formed as a single one on the same concentric circle, it is also possible to form it by dividing it into a plurality of photodetector elements. In addition, while at least two concentric circles are required in order to take out the differential signal from two different concentric photodetector elements as described later, it is also possible to form a plurality of them not limiting it to two pieces.

In general, the laser diode used as the vertical cavity surface emitting device greatly depends on temperature, and its luminescent output changes over time. In addition, change of the light amount also occurs due to change of a driving current of the laser diode and so on.

For that reason, if a light emitting signal is directly or indirectly inputted to the photodetector element as-is without taking any action, the output taken out of the photodetector element changes as-is according to the change of the light amount of the laser diode.

In such a state, an error due to the temperature dependency and the change of the driving current occurs to an output signal from the photodetector element.

In case of taking out a reflected light signal with the photodetector element in the optical microphone device of the present invention, there is a possibility that the change of the light amount due to the temperature dependency of the light emitting laser signal and the change of the driving current and so on occurs.

In order to solve this problem, a plurality of photodetector elements are placed in the present invention so as to take out differentials of the signals received thereby.

In addition, as the plurality of the photodetector elements are manufactured in the same manufacturing process in the present invention, variations thereof are extremely small so that problematic denying errors can be rendered minimum by removing the differentials thereof.

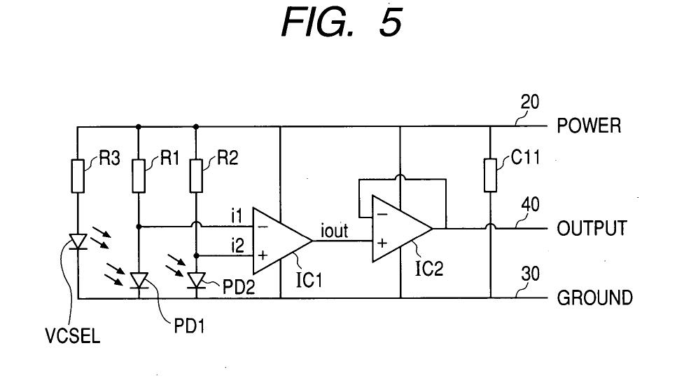

FIG. 5 shows an example of an electrical equivalent circuit of the optical microphone apparatus of the present invention.

Here, the VCSEL represents the vertical cavity surface emitting laser diode, and the PD1 and PD2 represent the photodetector elements such as the photodiodes provided to surround the VCSEL.

The VCSEL and the photodetector elements PD1 and PD2 are serially connected between a power supply 20 and a ground 30 via resistances R3, R1 and R2, and have the configuration to pass predetermined driving currents respectively.

A node between the resistance R1 and the photodetector element PD1 is connected to an inversion input terminal of a differential amplifier IC1. In addition, the node between the resistance R2 and the photodetector element PD2 is connected to a non-inversion input terminal. The output of the differential amplifier IC1 is taken out by a differential amplifier IC2 for a buffer so as to obtain an output 40. Moreover, a bypass capacitor C11 for erasing a noise signal is connected between the power supply 20 and the ground 30.

The incident light irradiated from the VCSEL is concentrically reflected on the vibrating board 2 to be inputted to the photodetector elements PD1 and PD2 respectively. Moreover, the vibrating board 2 is placed almost in parallel with and very close to the substrate 9.

In addition, it is possible to consider that the vibrating board 2 is almost moving in parallel with the substrate 9 because its displacement amount (movement amount) is 1 micron or so.

Moreover, while the example shown in FIG. 5 shows that the photodetector element PD1 concentrically placed inside is connected to the inversion input terminal and the photodetector element PD2 placed outside is connected to the non-inversion input terminal, they do not necessarily have to be thus connected but may be connected to optimum terminals depending on design status of actual circuits.

In addition, there is a relationship of iout=i1−i2 between an output current iout and differential input currents i1 and i2 of the differential amplifier IC1.

Here, in the case where there is change of δ i1 and δ i2 to the differential inputs i1 and i2 independently, it is iout=((i1+δi1)−(i2+δi2)).

If the photodiodes PD1 and PD2 simultaneously change here, the changes amounts δi1 and δi1=δi2, and it is i out=i1−i2.

Accordingly, even if change occurs to the light of emission of the VCSEL due to change of the temperature or the driving current, the change is conveyed simultaneously to the photodetector elements PD1 and PD2 and is canceled, so that the variations of the VCSEL do not appear in the differential output iout.

In addition, in the case of the independent change with different sizes of the currents, it is [(i1−i2)+((δi1−δi2)) and the differential appears as the change of the output.

This represents that the reflected light signal changes due to the change of the vibrating board such as the vibration and the displacement, and so the change occurs to the reflected light concentrically received so as to have different input change in each photodetector element.

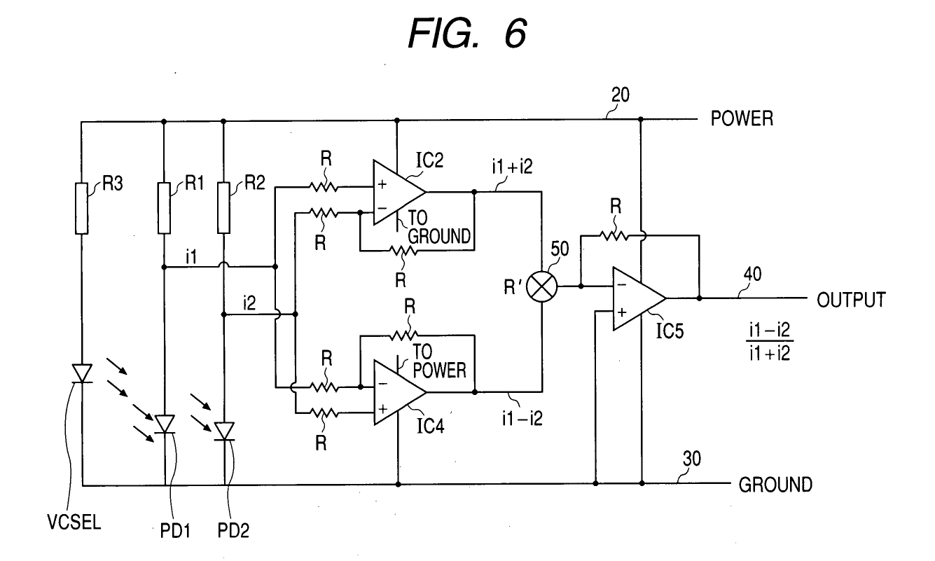

FIG. 6 is a circuit diagram showing another configuration of the electrical equivalent circuit of the optical microphone apparatus of the present invention. In this embodiment, the input currents i1 and i2 are inputted to an adder IC3 and a subtraction circuit IC4 via the resistance R respectively. And the output current i1+i2 of the adder IC3 and the output current i1−i2 of the subtraction circuit IC4 are inputted to a circuit 50. The output in inverse proportion to the output current i1+i2 is obtained from the output of the circuit 50. The output of the circuit 50 is taken out to the output 40 as (i1−i2)/(i1+i2) via an operator IC5. Thus, the division circuit is comprised of the circuit 50 and the operator IC5.

If such a circuit configuration is adopted, it is possible, in the case where both the input currents i1 and i2 increase or decrease, to obtain a more stable output compared to the circuit configuration in FIG. 5.

In the configuration of the optical microphone apparatus of the above-mentioned present invention, movement displacement of the vibrating board is ±0.5 μm or so against the sound pressure of an extraneous sound wave if the vibrating board of a small diameter of 3 mm or so (membrane) is used. And the movement width (displacement width) of the light in the light-receptive portion is 0.21 μm or so as a half value width if the radiation angle of the laser is 12 degrees.

Accordingly, the change of an electric signal in the photodetector element of which movement width is 0.21 μm in a half value angle position and 0.42 μm or so at the full angle at half maximum width is amplified by the differential amplifier or the amplifier such as an analog divider. Here, in order to increase the output of the amplifier to a practical level, it is necessary to increase an amplification factor of the amplifier, resulting in a complicated design thereof.

In addition, if the amplification factor is increased, the noise generated on the electronic circuit also increases, and so it becomes difficult to render a signal/noise (S/N) ratio high.

Thus, a further improvement is added to the present invention. To be more specific, a technical approach for increasing the movement width of the reflected light is adopted in order to enhance acoustoelectric conversion efficiency. Hereafter, an embodiment of the improvement invention will be described.

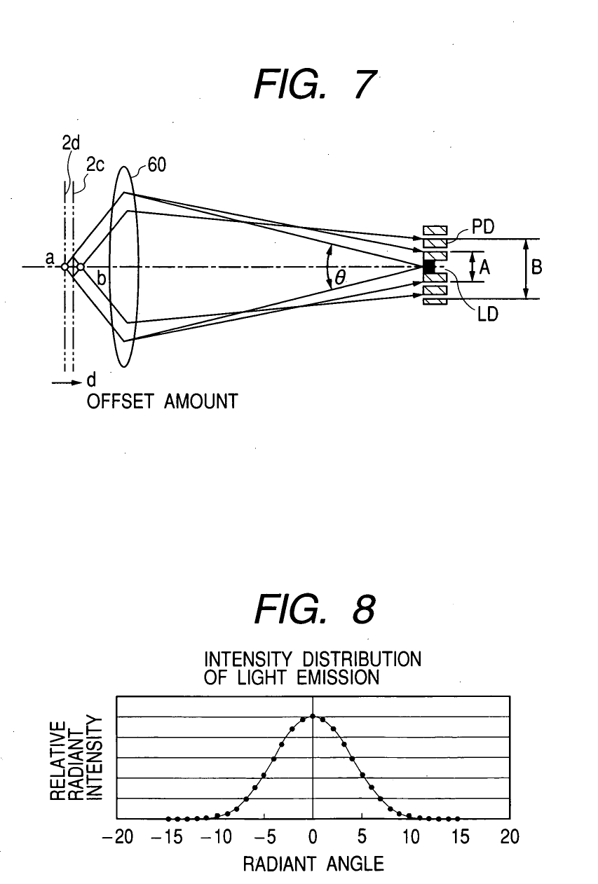

In this improvement invention, a lens element 60 is placed on an optical path between the substrate 9 and the vibrating board 2 as shown in FIG. 7.

Moreover, in FIG. 7, the configuration other than the lens element 60 is the same as that shown in FIG. 4, and so it is numbered likewise and the detailed description thereof will be omitted.

The lens element 60 placed on the optical path focuses the incident light from the luminescent device LD to lead it to the vibrating board 2 and focuses diverging reflected light from the vibrating board 2 to lead it to the photodetector element PD.

A microlens or a hologram may be used as the lens element 60. While the microlens may be used as a single unit, it is also possible to form a lens on a slab glass by ion exchange and use the luminescent device and photodetector element by keeping them in absolute contact therewith.

In the embodiment shown in FIG. 7, the distance between the luminescent device LD and the vibrating board 2 is 1.3 mm, and the lens element 60 of which lens diameter is 0.25 mm and magnification is 6.5 is placed on the optical path.

The vibrating board 2 is placed in proximity to a focus position of the lens element 60, which is a reference position. A point a in FIG. 7 shows an imaging position. In addition, a point b shows an imaging point in the position where it has reflected on the vibrating board 2 and folded back. Moreover, the state shown in FIG. 7 is the state where the vibrating board 2 is dented by high pressure. An angle θ is determined by a convergent angle of the lens element 60, and it is θ 12 degrees in this embodiment. Δ shows the displacement of the imaging position from the reference position on an optical axis, and is calculated by an equation (7) assuming that M is a magnification of a lens element 3.
Δ=2×δ×M²=2×8×6.5² (7)

If the reference distance between the luminescent device LD and photodetector element PD and the vibrating board 2 is a reference inter-image distance L₀ of the lens, a distance L between the lens and the luminescent device LD and photodetector element PD is acquired as an approximate value by the following equation.
L=L₀×M/(1+M) (8)

Moreover, FIG. 7 shows the case where the position apart from the luminescent device LD by A/2 becomes B/2 due to the displacement 2δ of the vibrating board 2.

B/2 of the displacement +δ is approximately calculated by an equation (9), and A/2 of the displacement −δ by an equation (10) respectively.
B/2=−(Hap)·[L−{L+(2d·M²)−(2δ·M²)}]/{L+(2d·M²)−(2δ·M²)} (9)
A/2=−(Hap)·[L−{L+(2d·M²)−(2δ·M²)}]/{L+(2d·M²)−(2δ·M²)} (10)

In addition, a displacement d of the vibrating board (reflector) 2 is an offset amount from the reference position. Furthermore, if it is defined as (Hap)=luminous flux height of external feedback, and when a projection radius at a vibrating board amplitude +δ is B/2 and that at the vibrating board amplitude δ is A/2, the change of the projection radius on the light-receptive portion is that if d is minus, the vibrating board goes away from the lens, and in this case, the luminous flux height (Hap) is δ/2 since the luminous flux returns by fully using the lens radius. On the other hand, when the vibrating board approaches the lens, d becomes plus and the luminous flux height of the external feedback becomes smaller by a ratio equivalent to 2d, so that the luminous flux height (Hap) is reduced. Here, calculation is performed and the results are shown in Table 2 as to the change of Δ, L, A/2, B/2 and the movement width when an offset amount d is changed on the conditions of a deflection of the vibrating board 2 being ±0.5 μm, L₀=1.39 mm, the lens diameter (φ) 0.25 mm and M=6.5.

TABLE 2

| | | | | | | | Movement |
|---|---|---|---|---|---|---|---|
| L₀ | d | ±δ | Δ | Hap | A/2 | B/2 | width |
| mm | μm | μm | μm | μm | μm | μm | μm |
| 1.39 | −5 | 0.5 | −423 | 0.13 | 78.5 | 57.7 | 20.86 |
| | −4 | 0.5 | −338 | 0.13 | 57.7 | 40.7 | 16.98 |
| | −3 | 0.5 | −254 | 0.13 | 40.7 | 26.6 | 14.09 |
| | −2 | 0.5 | −169 | 0.13 | 26.6 | 14.7 | 11.88 |
| | −1 | 0.5 | −85 | 0.13 | 14.7 | 4.54 | 10.16 |
| | 0 | 0.5 | 0 | 0.13 | 4.54 | −4.2 | 8.78 |
| | 1 | 0.5 | 84.5 | 0.12 | −4.2 | −12 | 7.58 |
| | 2 | 0.5 | 169 | 0.12 | −12 | −18 | 6.60 |
| | 3 | 0.5 | 254 | 0.12 | −18 | −24 | 5.80 |
| | 4 | 0.5 | 338 | 0.12 | −24 | −29 | 5.12 |
| | 5 | 0.5 | 423 | 0.12 | −28 | −33 | 4.55 |

As for the example shown in Table 2, the case where the vibrating board 2 is placed in a focal position of the lens element 3 is the reference position (=0), and the calculation is performed by offsetting it just by d (±0.5 μm in the table) and thus changing the amplitude of the vibrating board by ±0.5 μm.

From the results of Table 2, it is understood that the movement width becomes larger, that is, light-receptive sensitivity becomes higher, by separating the vibrating board 2 to be several μm farther from the focal position of the lens element 3.

In addition, it is compared to the case of having no lens element shown in FIG. 4 in order to compare a magnifying effect of the lens.

In the case of the configuration using no lens that is an improvement technique shown in Table 1, it has significantly increased compared to 0.21 μm of the movement width when the radiation angle of the light from the luminescent device LD is 12 degrees.

Thus, the reflected light from the vibrating board 2 changes, by placing the lens element 3 on the optical path, by the amount of twice the displacement amount δ of the vibrating board 2 multiplied by a square of an optical magnification M.

To be more specific, the movement width of 84 times the displacement amount δ of the vibrating board 2 can be obtained. Moreover, it is needless to say that the present invention is not limited to the optical microphone apparatus but is also applicable to an optical sensor.

Next, the embodiment related to the second phase of the present invention will be described.

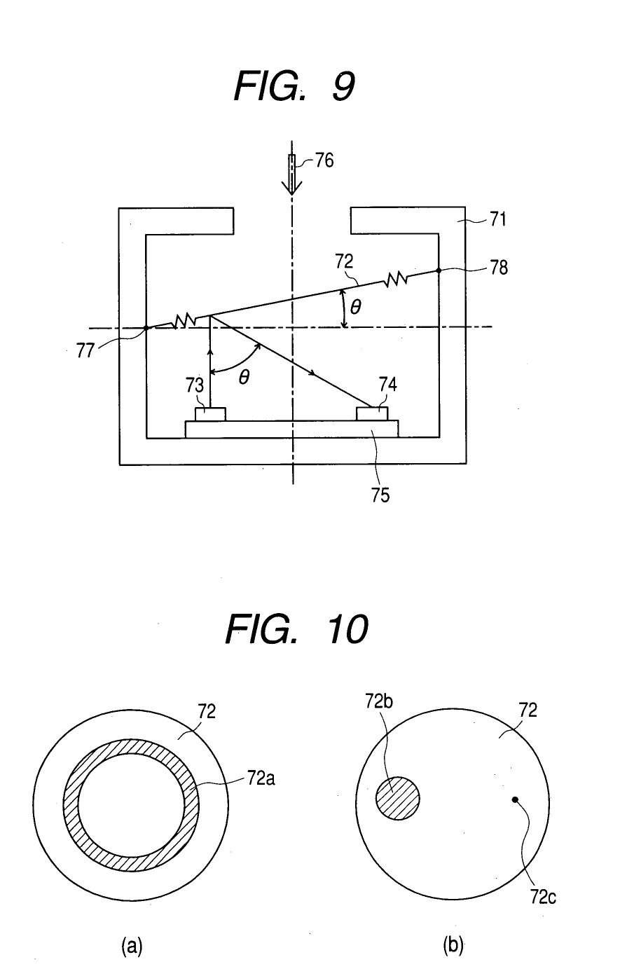

FIG. 9 is a sectional view showing the configuration of a head portion of the optical microphone apparatus as an example of the embodiment related to the second phase of the present invention.

In the present invention, a luminescent device 73 and a photodetector element 74 to be mounted on a substrate 75 are placed thereon so that the light emitting surface and a light-receptive surface will be parallel and almost on the same plane without having an angle. And a light beam is emitted to a vibrating board 72, almost vertically to the light emitting surface, from the luminescent device 73.

Next, at the time of mounting the vibrating board 72 with fulcrums 77 and 78 in the present invention, it is mounted by inclining it to the substrate 75 by the predetermined angle θ. And the angle made by the incident light and the reflected light caused by the fact that the light beam from the luminescent device 73 is reflected by the vibrating board 72 and reaches the photodetector element 74 is rendered equal to an inclination angle θ of the vibrating board 72.

Thus, it is possible to improve productivity by flatly mounting the luminescent device 73 and the photodetector element 74 on the substrate 75.

Here, the incident light can be obtained in a direction vertical to the light emitting surface of the luminescent device 73 by using a vertical cavity surface emitting luminescent device as the luminescent device.

In addition, as for the photodetector element 74, the reflected light incident thereon inclines to the light-receptive surface, while the photodetector element in general does not have its sensitivity to an incident angle of the received light so much deteriorated compared to the luminescent device, so that light-receptive efficiency does not remarkably deteriorate even if the incident angle is not necessarily vertical to the light-receptive surface.

Moreover, it is possible to use the VCSEL shown in FIG. 1 as the luminescent device 73 in the configuration shown in FIG. 9.

In this case, a gallium arsenide wafer or the like is used as the substrate 75, and a VCSEL 3 and a PD 4 are formed thereon. Moreover, it is also feasible to place a plurality of the PDs 4, and it is not necessary to concentrically form the PDs 4 to surround the VCSEL 3. It is possible, by thus forming it, to receive by the PDs 4 the portion of the highest intensity of the light emission from the VCSEL 3. In addition, in the case where a plurality of the PDs 4 are placed, it is possible to implement miniaturization by affixing on a substrate 5 by flip chip bonding and so on the electronic circuit of the differential amplifier not shown for receiving the signal from the PDs 4.

FIG. 10 shows a surface shape of the vibrating board 72.

As previously mentioned, in the case of using the vertical cavity surface emitting luminescent device (VCSEL) as the luminescent device 73, the light from the light emitting surface is concentrically radiated with the even intensity of the light emission, and so the light-receptive surface of the vibrating board 72 can be annularly mirror-finished so as to improve reflection efficiency thereon.

An area 72a diagonally shaded in FIG. 10 shows such a mirror-finished area. In addition, it is also possible to mirror-finish only a spot-like area 72b on which the light beam is incident as shown in FIG. 10(b). An area 72c represents a positioning point at the time of mounting the vibrating board 72 on the fulcrums 77 and 78.

FIG. 11 is a diagram for explaining an operation of the head portion of the optical microphone apparatus according to the present invention.

A luminous flux L1 of the light beam emitted from the luminescent device 73 hits a predetermined area of the vibrating board 72 mounted at an angle inclined by θ against the substrate 75, where it is reflected to become a reflected luminous flux L2 and gets incident on the photodetector element 74. At this time, the vibrating board 72 vibrates due to the sound wave so that the reflected luminous flux L2 changes according to the size of the vibration displacement as shown by solid lines, broken lines and chain lines in the drawing, and gets incident on another light-receptive surface of the photodetector element 74.

Accordingly, it is possible to detect the vibration displacement of the vibrating board 72 by detecting the size of the light signal in this light-receptive position.

While the above-mentioned configuration related to the second phase of the present invention is very useful compared to the prior art, the following problem is immanent therein.
(i) As the luminous flux from the luminescent device 3 to be vibrating board is normally irradiated by becoming 5 to 10 degrees wider and reflected on the vibrating board 2, there are the cases where the reflected light is irradiated by expanding beyond the light-receptive surface of the photodetector element.
(ii) There are the cases where, due to the vibration of the vibrating board, the focus of the reflected light is not necessarily fixed on the light-receptive surface of one photodetector element, so that the light-receptive efficiency decreases.
(iii) There are also the cases where the optical axis of the light beam radiated from the luminescent device is not necessarily erected vertically to the radiated surface.

For this reason, there is a problem that all the reflected light cannot be efficiently received just by placing one photodetector element for receiving the reflected light in a fixed position on the substrate.

Thus, the second phase of the present invention has a further improvement technique adopted in order to solve the above problem.

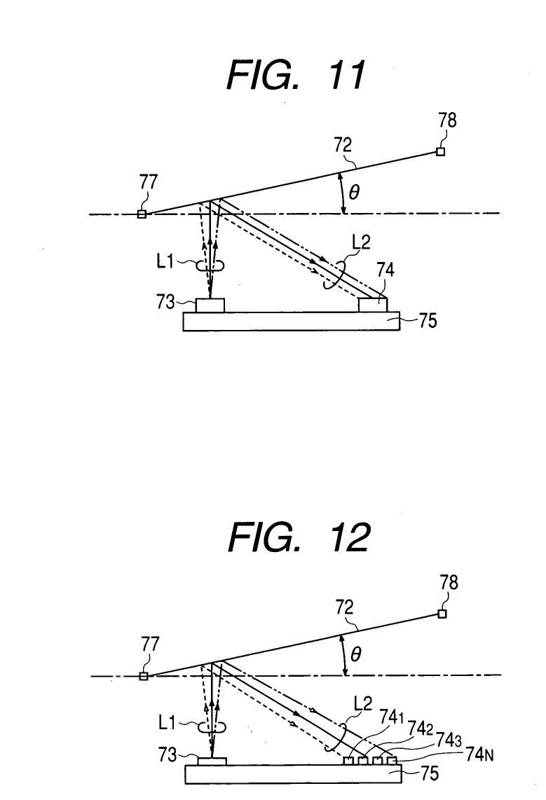

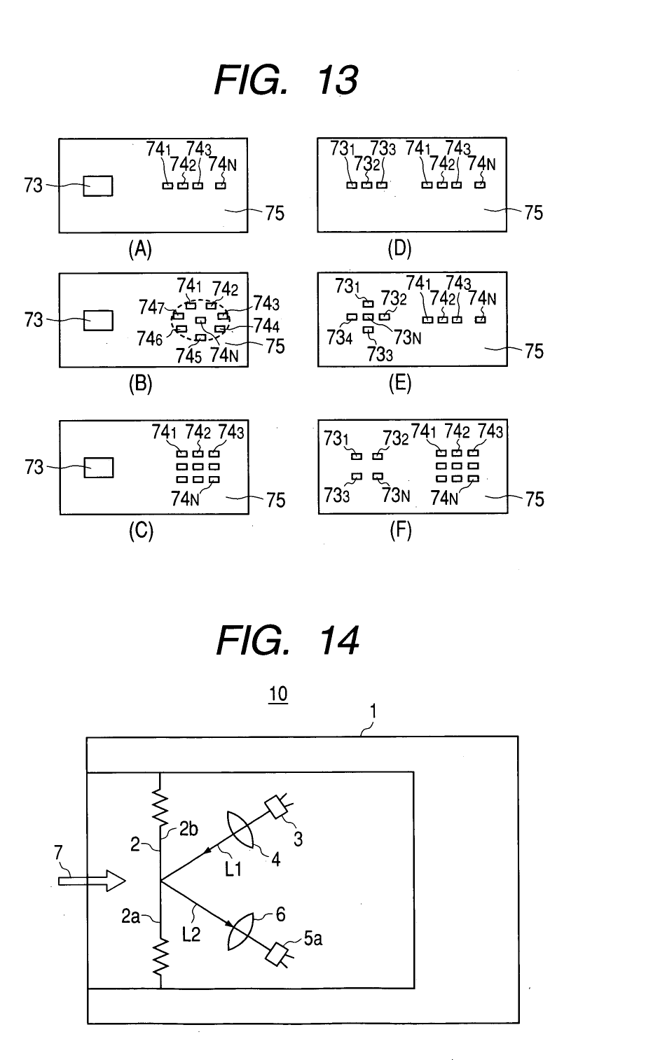

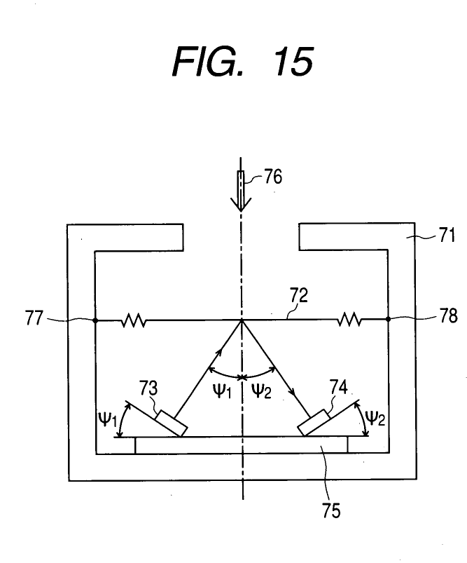

FIG. 12 is a diagram showing the configuration of the head portion of the optical microphone apparatus which is an example of the embodiment of such improved invention. Moreover, the same portions as those shown in FIGS. 9 and 11 are numbered likewise and the detailed description thereof is omitted.

In this improved invention, the photodetector element 74 shown in FIG. 9 or FIG. 11 is divided into a plurality, and such divided photodetector elements 74₁, 74₂, 74₃, . . . 74ₙ are arranged in a predetermined form.

Thus, it is possible, by thus using the plurality of photodetector elements 74₁, 74₂, 74₃, . . . 74ₙ, to absorb and receive all the expanse of the luminous flux L2 reflected by the vibrating board 72.

As the embodiment shown in FIG. 12 has one luminescent device 73 and a plurality of the photodetector elements 74, it is possible to absorb and receive all the reflected light L2 of a radial beam from the luminescent device 73.

Moreover, while it is possible to linearly arrange the photodetector elements 74 against the luminescent device 73 as shown in FIG. 13A, it is also feasible, for instance, to circularly arrange the plurality of photodetector elements 74₁. . . 74ₙ as shown in FIG. 13B and to rectangularly arrange them as shown in FIG. 13C.

In addition, it is feasible to divide and arrange not only the photodetector element 74 but also the luminescent device 73.

FIG. 13D shows the case where the luminescent device 73 is divided and linearly arranged just like the photodetector elements 74. In addition, the luminescent device 73 is divided and circularly arranged in FIG. 13E, whereas it is divided and rectangularly arranged in FIG. 13F.

Thus, it is possible to further enhance light emitting efficiency by dividing the luminescent device 3 and placing a plurality thereof.

FIG. 10 is a diagram showing a surface shape of the vibrating board 72.

In case of using the vertical cavity surface emitting luminescent device (VCSEL) as the luminescent device 73, the light from the light emitting surface is concentrically radiated with the even intensity of the light emission, and so the light-receptive surface of the vibrating board 72 can be annularly mirror-finished so as to improve reflection efficiency thereon.

An area 72a diagonally shaded in FIG. 10 shows such a mirror-finished area.

In addition, it is also possible to mirror-finish only a spot-like area 72b on which the light beam is incident as shown in FIG. 10B. An area 72c represents a positioning point when mounting the vibrating board 72 on the fulcrums 77 and 78.

While the optical acoustoelectric transducer of the present invention was described above by taking the optical microphone apparatus as an example, it is needless to say that the present invention is not limited thereto but is broadly applicable to an acoustic sensor and so on.

### INDUSTRIAL APPLICABILITY

As described in detail above, as a characteristic of the first phase of the present invention, it allows the luminescent device and the photodetector element to be simultaneously formed on the same substrate so that the alignment accuracy thereof can be 1 μm or less, that is, high accuracy of a one millionth or less compared to that of the luminescent device and photodetector element of the past.

In addition, as it adopts the structure wherein the vertical cavity surface emitting luminescent device of which intensity distribution of the light emission is concentrically almost even is placed and the photodetector elements to surround it are concentrically provided, it is possible to render the outputs from the plurality of photodetector elements as the differential signals so as to detect and output the differentials thereof.

Accordingly, it is possible, compared to the cases where a single photodetector element is used as the output signal, to reduce the influence of the temperature change of the luminescent device, change of the driving current and so on so as to obtain a stable signal output.

Furthermore, it is feasible to significantly increase the movement width of the reflected light by coaxially placing the luminescent device and photodetector element on the optical axis of the lens element between the substrate on which the luminescent device and photodetector element are mounted and the vibrating board.

Accordingly, it is possible to implement reproduced sound of a high S/N ratio without increasing the amplification factor of the amplifier.

In addition, according to the second phase of the present invention, the luminescent device and the photodetector element are levelly placed to the substrate so that they are easily mounted and have excellent productivity.

Moreover, it is thinkable that, as the inclination of the vibrating board is slight, the vibrating board is mounted in parallel with the substrate on which the luminescent device and photodetector element are mounted. For this reason, it is feasible, in the present invention, to configure an optical microphone apparatus of which focusing of the incident light and the reflected light is easy and productivity is excellent even if there are variations in the components comprising the head portion of the optical acoustoelectric transducer.

Furthermore, at least a plurality of the photodetector elements are levelly placed to the substrate so as to receive the reflected light from the luminescent device just sufficiently. For this reason, it is possible to implement the optical acoustoelectric transducer of high light-receptive efficiency.

In addition, it is possible to comprehensively improve the S/N ratio because thermal noise of the photodetector elements can be curbed by subdividing the elements and providing a plurality of them.

1. An optical acoustoelectric transducer having a luminescent device and a photodetector element placed on the same substrate, wherein light is emitted to a vibrating board mounted in a position opposite said substrate from said luminescent device, and the reflected light from said vibrating board is received on said photodetector element so as to detect displacement of said vibrating board,
characterized in that a vertical surface-emitting luminescent device having a substantially uniform concentric intensity distribution of light emission around the center of a light emitting area is placed as said luminescent device in a center of said substrate and said photodetector element is provided to surround said luminescent device.

2. The optical acoustoelectric transducer according to claim 1,
wherein in that said photodetector element is comprised of a plurality of concentrically placed devices.

3. An optical acoustoelectric transducer having a differential detector for detecting a differential signal between signals detected by photodetector elements belonging to different concentric circles so as to detect the displacement of said vibrating board from output of said differential detector.

4. The optical acoustoelectric transducer according to any one of claims 1 to 3,
wherein said luminescent device and photodetector element are simultaneously formed on said substrate.

5. The optical acoustoelectric transducer according to any one of claims 1 to 4,
wherein said substrate is comprised of a gallium arsenide wafer.

6. The optical acoustoelectric transducer according to any one claims 1 to 5,
wherein said vibrating board is mounted almost in parallel with and close to said substrate.

7. The optical acoustoelectric transducer according to any one of claims 1 to 6,
wherein a lens element for focusing incident light from said luminescent device to lead it to said vibrating board and focusing diverging reflected light from said vibrating board to lead it to said photodetector element is placed on an optical path between said substrate and said vibrating board so as to have said luminescent device on an optical axis thereof.

8. The optical acoustoelectric transducer according to claims 7,
wherein said lens element is a microlens.

9. The optical acoustoelectric transducer according to claims 7,
wherein said lens element is a hologram.

10. The optical acoustoelectric transducer according to any one of claims 7 to claim 8,
wherein said lens element is placed to have said vibrating board located in a position slightly farther than a focus position of said lens element.

11. An optical acoustoelectric transducer having a vibrating board vibrating due to sound pressure, a luminescent device for irradiating a light beam on said vibrating board, a photodetector element for receiving reflected light of said light beam irradiated on said vibrating board and outputting a signal corresponding to the vibration displacement of said vibrating board, and a substrate for mounting said luminescent device and said photodetector element,
characterized in that
said luminescent device and one or a plurality of said photodetector elements are placed on said substrate so as to arrange in parallel and almost on the same plane; a light emitting surface of said luminescent device and a light-receptive surface of said photodetector element;
said vibrating board is inclined by a predetermined angle to said substrate, and said light beam emitted almost vertically to said light emitting surface from said luminescent device is irradiated on said vibrating board; and
said reflected light on said vibrating board is received by said one or a plurality of photodetector elements.

12. The optical acoustoelectric transducer according to claims 11,
wherein an area of said vibrating board on which said incident light is irradiated is made of a mirror surface.

13. The optical acoustoelectric transducer according to claim 12,
wherein said area is annularly formed.

14. The optical acoustoelectric transducer according to claims 12,
wherein said area is formed in a circular spot shape.

15. The optical acoustoelectric transducer according to claim 11,
wherein a plurality of said photodetector elements are linearly arranged against said luminescent device.

16. The optical acoustoelectric transducer according to claim 11,
wherein a plurality of said photodetector elements are circularly arranged.

17. The optical acoustoelectric transducer according to claim 11,
wherein a plurality of said photodetector elements are rectangularly arranged.

18. The optical acoustoelectric transducer according to any one of claims 11 to 17,
wherein a plurality of said luminescent devices are provided.
